(19) United States
(12) Patent Application Publication
(10) Pub. No.: US 2019/0358657 A1
(43) Pub. Date: Nov. 28, 2019

(54) BOX PUMP SYSTEM AND METHOD OF USE

(71) Applicant: MacLean-Fogg Company, Mundelein, IL (US)

(72) Inventor: Christian Muehlich, Whitewater, WI (US)

(73) Assignee: MacLean-Fogg Company, Mundelein, IL (US)

(21) Appl. No.: 16/421,090

(22) Filed: May 23, 2019

Related U.S. Application Data
(60) Provisional application No. 62/676,470, filed on May 25, 2018.

(51) Int. Cl. B05B 11/00

(52) U.S. Cl. CPC B05B 11/0037; B05B 11/0062; B05B 11/3073; B05B 11/3067; B05B 11/3004

(57) ABSTRACT

Pump systems and methods are disclosed for removing liquid for hand-portable containers. The pump systems include a moveable piston housed in a main chamber and inlet and outlet valves located at one end of the main chamber, where the inlet and outlet valves open and close in response to movement of the piston.

### CROSS-REFERENCE TO RELATED APPLICATIONS

This application claims the benefit of co-pending U.S. Provisional Application No. 62/676,470, filed May 25, 2018. The contents of U.S. Provisional Application No. 62/676,470 are incorporated by reference in their entirety.

### BACKGROUND

The present invention relates generally to pump systems for removing liquid from hand-portable containers. It can be difficult to remove liquids from hand-portable containers without needing to tip or overturn the containers. Pumps can be used to draw liquid from the containers, but pumps can be large, expensive, difficult to transport, difficult to securely attach to the container, and difficult to operate by hand. Accordingly, there is a growing need for easy to use and cost effective pumps for removing liquids from hand-portable container.

### SUMMARY

In one embodiment, a pump system comprises a housing comprising a main chamber and an outlet channel, wherein the main chamber has a first end and a second end; a piston moveable within the main chamber, wherein a portion of the piston is configured to move at least partially out of the first end of the main chamber; an inlet valve located at the second end of the main chamber and in fluid communication with the main chamber and an inlet opening, wherein the inlet valve is configured to open when the piston moves away from the inlet valve and is configured to close when the piston moves toward the inlet valve; an outlet valve located at the second end of the main chamber and in fluid communication with the main chamber and the outlet channel, wherein the outlet valve is configured to open when the piston moves toward the outlet valve and is configured to close when the piston moves away from the outlet valve; and a spring configured to bias the piston away from the inlet valve.

In another embodiment, a method of removing liquid from a container with a pump system is disclosed, the pump system comprising a main chamber, a piston moveable within the main chamber, an inlet valve in fluid communication with the main chamber, an outlet valve in fluid communication with the main chamber, and an outlet channel in fluid communication with the outlet valve, the method comprises moving the piston away from the inlet valve to close the outlet valve and draw liquid from a container into the main chamber through the inlet valve and moving the piston toward the outlet valve to close the inlet valve and push liquid from the main chamber into the outlet channel through the outlet valve.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective side cross-sectional view of a pump system according to an embodiment of this disclosure.

FIG. 2 is a bottom cross-sectional view of part of a pump system according to an embodiment of this disclosure.

FIG. 3 is a cross-sectional end view of a pump system according to an embodiment of this disclosure.

FIG. 4 is a perspective view of a pump system according to an embodiment of this disclosure.

### DETAILED DESCRIPTION OF THE DRAWINGS

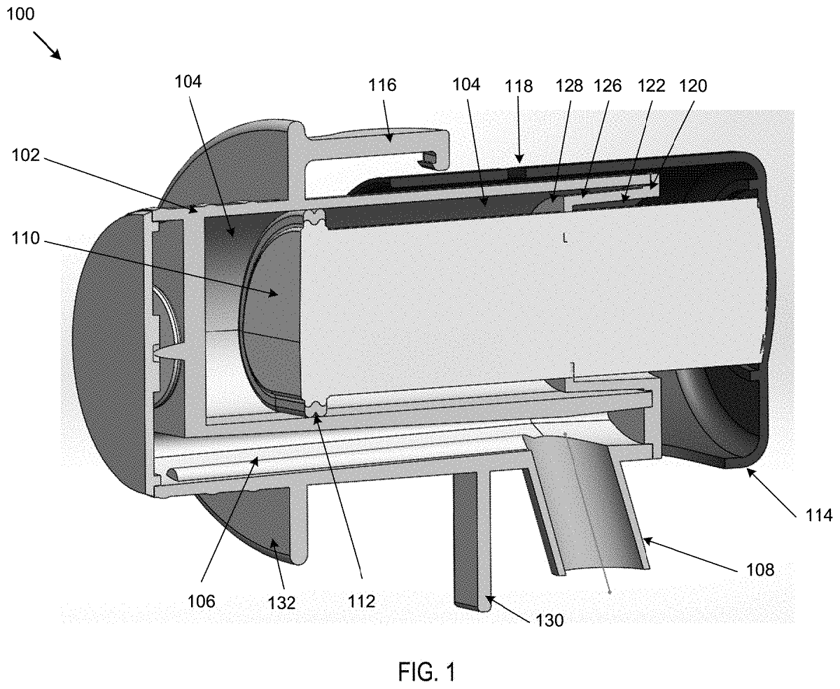

Referring now to the figures, FIG. 1 shows an embodiment of a pump system 100. FIG. 1 shows a side cross-sectional view of pump system 100. Pump system 100 may include a housing 102. Housing 102 may be substantially hollow and main include main chamber 104. Outlet channel 106 may also be located within housing 102. Outlet channel 106 may be located parallel and adjacent to main chamber 104. Outlet channel 106 may be in fluid communication with spout 108 such that liquid may flow from outlet channel 106 to spout 108. A receptacle (not shown) may be placed under spout 108 to collect liquid flowing out of spout 108. Spout 108 may be angled to direct liquid flowing out of spout 108 away from the container (not shown) connected to pump system 100.

A piston 110 may be located in main chamber 104. Piston 110 may fit tightly within main chamber 104 such that liquid on one side of piston 110 may not travel to another side of piston 110. Piston 110 may include a seal 112 to prevent liquid from traveling from one side of piston 110 to another side of piston 110. Seal 112 may keep liquid on the left side of piston 110 within main chamber 104, as shown in FIG. 1.

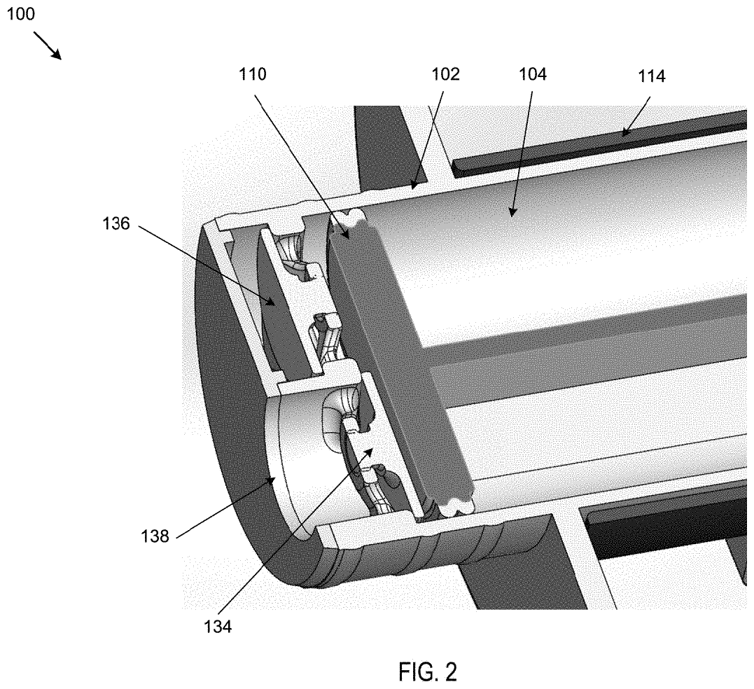

Piston 110 may be axially moveable within main chamber 104 such that piston 110 can slide from one end of main chamber 104 to the other end of main chamber 104. FIG. 1 shows piston 110 on the left side of main chamber 104. Moving piston 110 axially from the left to the right side of main chamber 104 may cause a vacuum in the space created to the left of piston 110 in main chamber 104 after piston 110 moves. The vacuum created may be used to draw liquid into main chamber 104 from a container (not shown) connected to pump system 100. Conversely, moving piston 110 axially from the right to the left side of main chamber 104 may push liquid out of main chamber 104 and into outlet channel 106. Inlet and outlet valves, as best shown in FIG. 2, may direct the flow of liquid into main chamber 104 and out of main chamber 104 into outlet channel 106. Repeated axial motion of piston 110 within main chamber 104 may be used to empty the container of liquid and/or fill a receptacle (not shown) placed under spout 108.

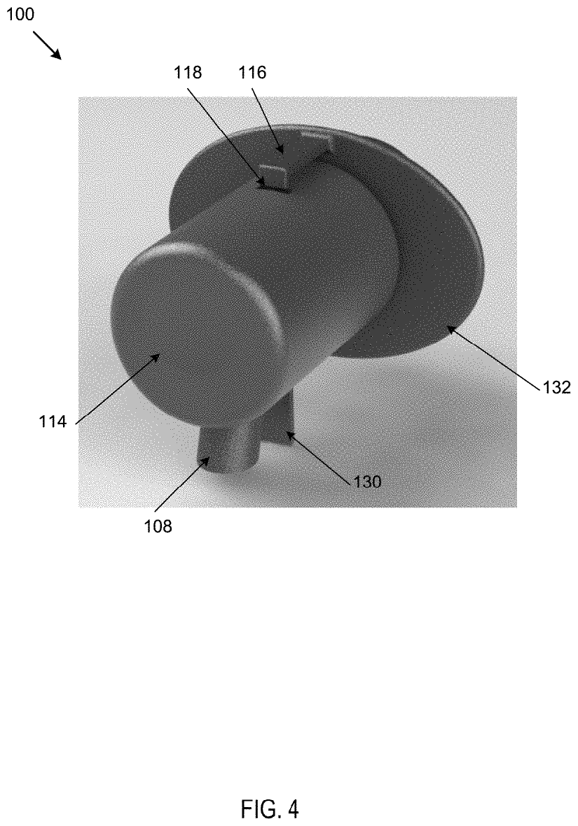

Pump system 100 may include cap 114 surrounding an end of housing 102. Cap 114 may be coupled to piston 110 such that cap 114 moves with piston 110 and moving cap 114 moves piston 110. Pump system 100 may include latch 116 on housing 102. An end of latch 116 may fit within lock slot 118 in cap 114 to releaseably lock housing 102 to cap 114. Latch 116 is not shown within lock slot 118 in FIG. 1 to improve clarity of the figure. Latch 116 may be oriented to fit within lock slot 118 as shown in FIG. 4. Latch 116 may fit securely within lock slot 118, for example, through an interference fit or by elastically deforming a portion of latch 116. Axial movement of cap 114, and consequentially piston 110, may be prevented when an end of latch 116 is located in lock slot 118. Accordingly, operation of pump system 100 may be prevented when an end of latch 116 is located in lock slot 118. Latch 116 may be released from lock slot 118 by depressing cap 114 axially from the left to the right, as shown in FIG. 1.

Pump system 100 may include flange 132 on housing 102. Flange 132 may act as a stop to prevent pump system 100 from moving in relation to a container (not shown) connected to pump system 100. For example, flange 132 may prevent pump system 100 from moving in relation to the container when cap 114 is depressed when pumping liquid from the container. Latch 116 may be coupled to flange 132. Flange 132 may extend annularly from housing 102, as shown in FIG. 1, or may only extend from a portion of housing 102.

Pump system 100 may include a spring (not shown) that is biased to move piston 110 from one side of main chamber 104 to the other. For example, the spring may move piston 110 from the left to the right side of main chamber 104, as shown in FIG. 1. The spring may be, for example, a helical spring that surrounds the shaft of piston 110. The spring surrounding the shaft of piston 110 may prevent the spring from buckling. Pump system 100 may include a spring pocket 120. The spring may be located in spring pocket 120. Spring pocket 120 may be attached to housing 102. The spring may be located in an annular space 122 surrounding piston 110 within spring pocket 120. Annular space 122 may be defined by inner wall 124 (not shown), outer wall 126, and end wall 128 of spring pocket 120. One end of the spring may press against end wall 128 while the other end of the spring presses against an inner surface of cap 114. When the spring uncoils it may move piston 110, which is coupled to cap 114. For example, uncoiling the spring may move piston 110 from the left to the right, as shown in FIG. 1. As discussed, moving piston 110 from the left to the right may draw liquid into main chamber 104 from a container (not shown) connected to pump system 100. Alternatively, pump system 100 may not include spring pocket 110 and the end of the spring not in contact with cap 114 may contact the end of piston 110 (left side of piston 110 in FIG. 1). Locating the spring in spring pocket 120 may reduce the required length of the spring because the end of the spring not in contact with cap 114 is closer to cap 114 with spring pocket 120 than if the end of the spring contacted the end of piston 110 without spring pocket 120.

Pump system 100 may include a protrusion 130 extending from housing 102. Protrusion 130 may be used as a grip location for a user's finger when the user is moving cap 114 and piston 110 to pump liquid from a container (not shown) attached to pump system 100. Protrusion 130 may provide a counteracting force to the force required to depress cap 114 and piston 110 when pumping liquid from the container. Protrusion 130 may be sized and shaped to accommodate a user's finger and the force required to move cap 114 and piston 110 when pumping liquid from the container. Protrusion 130 may extend from a lower portion of housing 102 and may be near spout 108, as shown in FIG. 1, or may extend from another portion of housing 102.

FIG. 2 shows a bottom cross-sectional view of a portion of an embodiment of pump system 100, including housing 102, main chamber 104, piston 110, and cap 114. Pump system 100 may include inlet valve 134 and outlet valve 136 within housing 102 and connected to main chamber 104. Inlet valve 134 and outlet valve 136 may act as check valves that only allow liquid flow in one direction through the valves. When inlet valve 134 is open, it may allow liquid flow from a container (not shown) into main chamber 104 through inlet opening 138. Inlet opening 138 may be connected to the container in any known manner, such as through a tube or other type of fluid conduit. When inlet valve 134 is closed, it may prevent liquid flow from main chamber 104 to inlet opening 138. When outlet valve 136 is open, it may allow liquid flow from main chamber 104 into outlet channel 106. When outlet valve 136 is closed, it may prevent liquid flow from outlet channel 106 into main chamber 104. Note that outlet channel 106 may be located in the portion of pump system 100 not shown in the FIG. 2 bottom cross-sectional view. Inlet valve 134 and outlet valve 136 may be sized such that the cross-section throughout the liquid flow path through each valve is nearly constant, which may provide an even and steady liquid flow through the valve during pumping. A reduced cross-section at any point of the flow path may cause turbulences and restrict the throughput of pump system 100. It may also increase the force that is required to operate pump system 100. Locating inlet valve 134 and outlet valve 136 on the same side of pump system 100 and main chamber 104 (left side in FIGS. 1 and 2) may allow the opposite side of main chamber 104 to remain free from liquid, which may prevent spilling or leaking liquid from the area of pump system 100 accessed by a user (right side in FIG. 1).

As previously discussed, moving piston 110 axially from the left to the right side of main chamber 104 (as shown in FIGS. 1 and 2) by depressing cap 114 may cause a vacuum in the space created to the left of piston 110 in main chamber 104 after piston 110 moves. The vacuum may open inlet valve 134 and allow liquid flow from the container (not shown) through inlet opening 138, through inlet valve 134, and into main chamber 104. The vacuum may also close outlet valve 136, preventing liquid flow between main chamber 104 and outlet channel 106. Moving piston 110 the opposite direction (from the right side to left side of main chamber 104) may close inlet valve 134 and open outlet valve 136, which may allow liquid flow from the main chamber 104 into outlet channel 106 through outlet valve 136. Liquid may then flow from outlet channel 106 into spout 108 and into a receptacle (now shown) below spout 108. Piston 110 may be moved in this opposite direction (from the right side to left side of main chamber 104) by the spring (not shown) located in spring pocket 120 surrounding piston 110. Additionally or alternatively, piston 110 may be moved in this opposite direction by pulling on cap 114.

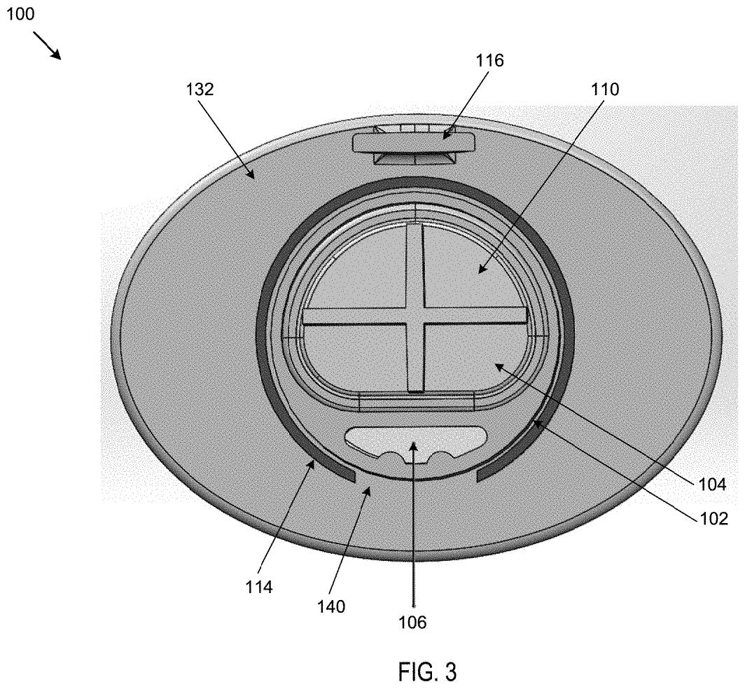

FIG. 3 shows a cross-sectional end view of an embodiment of pump system 100. FIG. 3 shows housing 102, main chamber 104, outlet channel 106, piston 110, cap 114, latch 116, and flange 132. Housing 102 may have a circular transverse cross-section, as shown in FIG. 3. FIG. 3 shows that the transverse cross-sections of main chamber 104 and piston 110 may not be circular, but instead may have a generally elliptical shape with semicircular top portions to match the circular cross-section of housing 102 with flattened bottom portions. Outlet channel 106 may be located in the space within housing 102 that is created by the flattened bottom portions of main chamber 104 and piston 110. Combining outlet channel 106 and elliptically shaped main chamber 104 in housing 102 may provide a compact design and may give pump system 100 a generally circular cross-section that may fit within the common circular openings in liquid containers that pump system 100 may be attached to.

FIG. 3 shows a slot 140 in cap 114. Slot 140 may be a space in cap 114 for spout 108 and protrusion 130. Slot 140 may allow cap 114 to fit over housing 102 and move axially on housing 102 without interference from spout 108 or protrusion 130. FIG. 3 also shows that flange 132 may not be a circular shape and may extend further from housing 102 in some areas, such as the left and right sides of flange 132.

FIG. 4 shows a perspective view of an embodiment of pump system 100. FIG. 4 shows spout 108, cap 114, latch 116, lock slot 118, protrusion 103, and flange 132. FIG. 4 shows latch 116 within lock slot 118, which may prevent cap 114 from moving axially away from flange 132 and housing 102. Latch 116 may be released from lock slot 118, which may release cap 114 from housing 102, by depressing cap 114 axially toward flange 132. Cap 114 may be locked to housing 102 by pressing latch 116 into lock slot 118.

While several embodiments of the pump system have been described, it should be understood that the pump systems are not so limited, and modifications may be made without departing from the disclosures herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the pump system, and it is not necessarily expected that all of the described advantages will be achieved with every embodiment of the pump system. The scope of the disclosure is defined by the appended claims, and all devices and methods that come within the meaning of the claims, either literally or by equivalence, are intended to be embraced therein.

1. A pump system comprising:
a housing comprising a main chamber and an outlet channel, wherein the main chamber has a first end and a second end;
a piston moveable within the main chamber, wherein a portion of the piston is configured to move at least partially out of the first end of the main chamber;
an inlet valve located at the second end of the main chamber and in fluid communication with the main chamber and an inlet opening, wherein the inlet valve is configured to open when the piston moves away from the inlet valve and is configured to close when the piston moves toward the inlet valve; and
an outlet valve located at the second end of the main chamber and in fluid communication with the main chamber and the outlet channel, wherein the outlet valve is configured to open when the piston moves toward the outlet valve and is configured to close when the piston moves away from the outlet valve.

2. The pump system of claim 1, wherein the housing is substantially cylindrical in shape and a transverse cross-section of the main chamber is non-circular, wherein the outlet channel is parallel to the main chamber and below the main chamber within the housing.

3. The pump system of claim 1, wherein the inlet valve and outlet valve are check valves.

4. The pump system of claim 1, wherein the inlet valve and outlet valve operate in response to motion of the piston.

5. The pump system of claim 1, wherein the inlet valve is adjacent to the outlet valve.

6. The pump system of claim 1, further comprising a cap coupled to the piston and surrounding the first end of the housing.

7. The pump system of claim 6, further comprising a spout in fluid communication with the outlet channel.

8. The pump system of claim 7, further comprising a protrusion extending from the housing configured to provide a counteracting force when the piston is moved toward the second end of the main chamber.

9. The pump system of claim 7, wherein the cap includes a slot to accommodate the spout and the protrusion.

10. The pump system of claim 6, further comprising a latch coupled to the housing, wherein the latch is configured to releaseably engage a space in the cap when an end of the piston is located adjacent to the second end of the main chamber.

11. The pump system of claim 1, further comprising a spring configured to bias the piston away from the inlet valve.

12. The pump system of claim 11, wherein the spring partially surrounds an end of the piston located near the first end of the main chamber.

13. The pump system of claim 11, further comprising a spring pocket at the first end of the main chamber, wherein the spring is partially located in the spring pocket.

14. The pump system of claim 13, wherein the spring pocket does not extend the entire length of the main chamber.

15. The pump system of claim 1, further comprising a flange extending annularly from the housing.

16. The pump system of claim 1, further comprising a seal between the piston and main chamber.

17. A method of removing liquid from a container with a pump system, the pump system comprising a main chamber, a piston moveable within the main chamber, an inlet valve in fluid communication with the main chamber, an outlet valve in fluid communication with the main chamber, and an outlet channel in fluid communication with the outlet valve, the method comprising:
moving the piston away from the inlet valve to close the outlet valve and draw liquid from a container into the main chamber through the inlet valve;
moving the piston toward the outlet valve to close the inlet valve and push liquid from the main chamber into the outlet channel through the outlet valve.

18. The method of claim 17, wherein the pump system further comprises a cap coupled to the piston and surrounding the first end of the housing and a latch coupled to the housing, wherein the latch is releaseably engaged with a space in the cap, the method further comprising the step of moving the cap toward the second end of the main chamber to disengage the latch from the cap.

19. The method of claim 18, wherein the pump system further comprises a spring biasing the piston away from the inlet valve, the method further comprising the step of uncoiling the spring to move the piston away from the inlet valve.

20. The method of claim 17, the method further comprising repeating the steps of claim to fill a receptacle downstream of the outlet channel.
